(19) United States
(12) Patent Application Publication
(10) Pub. No.: US 2005/0144444 A1
(43) Pub. Date: Jun. 30, 2005

(54) Data card and authentication process therefor

(76) Inventors: Timothy Grant Hall, Cambridge, MA (US); Anthony Mark Swierzbin, Chelmsford, MA (US)

Correspondence Address: James R. Dann;DOT, C-10, 400 7th St. SW, Washington, DC, 20590, US

(21) Appl. No.: 10/748,184

(22) Filed: Dec. 31, 2003

(51) Int. Cl. H04L 9/00

(52) U.S. Cl. 713/168

(57) ABSTRACT

A secure method of authenticating an identification card, etc. The card is produced with a picture of anything desired on it along with the signature of the holder of the card, and digital copies of the photograph and signature are made. Certain pixels in the digital photograph and signature are chosen according to a characteristic value function algorithm, which can vary from card to card, and their values are recorded on the card, preferably on a magnetic strip, along with the cardholder's name and instructions for starting the authentication process. The digital photograph and signature are stored in a first remote location, and the characteristic value function algorithm is stored in a secure second remote location along with a digital processor. When the card is presented for authentication, the person to whom it is presented swipes it in a magnetic card reader. The cardholder's name and the pixel values are sent to the first remote location, and then sent along with the digital copies of the photograph and signature to the secure second remote location. The digital processor then uses the characteristic value function algorithm to determine the pixel values from the digital photograph and signature. If these match the values that were sent to it the card is declared authentic.

Counterfeiting such a card requires that someone hack into two locations, the one containing the characteristic value function algorithm and the one containing the digital photograph and signature, and insert material into each one. This increases the security of the entire system by considerably more than a factor of 2.

### BACKGROUND

The present invention was conceived in the context of aircraft pilot identification, but it can be used in any situation that requires positive verification of the identity of an individual carrying an identification card.

As is well known, most identification methods that require verification can be defeated quite easily. All that is required is that a person hack into a database containing the information used for verification and insert his or her own photograph, signature, or whatever is used for verification. At an even more basic level, there are web sites that allow the user to create a counterfeit driver's license for just about any state by inserting the user's photograph, signature, and vital statistics into a form on the web site and then printing out and laminating the resulting “license”.

A successful verification system should be fast and easy to use, otherwise it would constitute a bottleneck in processing large numbers of people. Ideally, the process would be set up to be started by swiping a card having a magnetic strip, barcode, optical storage area, or any combination thereof on it through a card reader such as is done today with credit cards. The process should also have more than one component of authentication, since the probability of someone hacking into more than one database increases geometrically rather than arithmetically with the increase in number of databases that need to be penetrated. The process of enrolling people in the system should also be convenient and fast in order to encourage its use. Ideally, it would also use existing equipment as much as possible in order to reduce the cost as much as possible.

### OBJECTS OF THE INVENTION

Accordingly, it is an object of the present invention to provide an identification system that provides a level of security that is greater than that in present systems.

It is a further object of the present invention to provide such a system that allows quick and easy enrollment of persons in it.

It is a further object of the present invention to provide such a system that is quick and easy to use.

It is a further object of the present invention to provide such a system that uses existing computer-related equipment to a large extent.

It is a further object of the present invention to provide such a system having a verification method comprising two or more components that are stored in physically separate locations for additional security.

### BRIEF DESCRIPTION OF THE DRAWINGS

FIG. 1 shows the overall, layout of the present invention.

FIG. 2 shows an identification card according to the present invention.

### SUMMARY

Briefly, the present invention comprises a system for creating an identification card incorporating a secure means of verifying both the card and the person presenting the card. When a person is to be enrolled in the system he or she provides unique information such as a photograph of anything desired which is to be incorporated on the card, and his or her signature, which is also unique to that person and incorporated on the card. The photograph and signature are digitally scanned and the grayscale or color plane values of certain pixels, chosen by means of a characteristic value function algorithm, are recorded on a magnetic strip, barcode, optical storage area, of a combination of these data storage media on the card along with the cardholder's name and any other desired information. The digital photograph and digital signature are recorded in a remotely located secure database. When the card is presented for authentication the holder's name is sent to the remote database, along with the pixel values that were recorded on the card. The pixel values and identifying information are then sent, together with the stored digital photograph and digital signature, to a remote, network-inaccessible processor. The characteristic value function algorithm that was used to determine the pixel values that are stored on the card is stored at this location; the digital processor uses it to determine the pixel values from the digital photograph and signature. The processor then compares the pixel values it received with the pixel values it determined from the digital photograph and signature. If they are not identical, a message is sent back to the point of authentication request indicating that the card is not authentic. If they are identical, a message is sent back confirming the authenticity of the card and holder; the stored digital photograph and signature are also sent back and displayed, to allow further visual authentication.

### DESCRIPTION OF THE PREFERRED EMBODIMENT

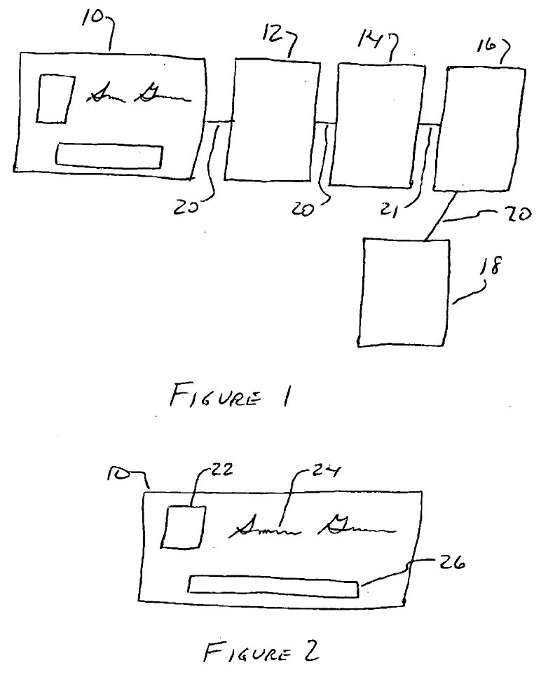

As shown in FIG. 1 the present invention comprises a system for creating and authenticating a secure identification card. The system comprises card 10 having a magnetic strip, barcode, optical storage area, or a combination of these data storage media on it, conventional card reader 12 for reading the data on card 10, database 14 at a first remote location, remote network-inaccessible processor 16 at a second remote location, and display means 18 located near card reader 12. Card reader 12 and display means 18 are placed in locations such as controlled access areas, stores, etc. where identification cards are presented for verification. All of the components except processor 16 are connected by means 20 such as conventional telephone wires, a wireless network, or the internet. Processor 16 is connected to database 14 by secure communication link 21, as is well known in the art, so that in use processor 16 can be accessed only from the first remote location housing database 14. Isolating processor 16 in this manner assures a high level of security for the overall system. For added security, the output from processor 16 can be sent to display means 18 by a secure communication link if desired.

FIG. 2 shows identification card 10 according to the present invention. It has on it certain unique information that in this example comprises photograph 22 and signature 24. Card 10 also has on it magnetic strip, barcode, optical storage area, or combination of these data storage media 26, which has encoded thereon the pixel values determined using the characteristic value function algorithm when the card was created. Card 10 may also contain any other information desired, either on its face or encoded onto storage medium 26. Photograph 22 may be of any subject desired by the owner of card 10; signature 24 is that of the card owner. Storage medium 26 also contains the information needed to begin the verification procedure.

To determine the pixel values to be encoded onto storage medium 26, photograph 22 and signature 24 are scanned to produce digital copies (not shown) which are comprised of discrete pixels, as is well known in the art. Then the digital photograph and digital signature are processed using a characteristic value function algorithm that selects certain pixels and reads their grayscale or color plane values, which are encoded as is well known in the art onto magnetic strip 26. The characteristic value function algorithm used to select the pixels may be the same for all cards or it may be varied from card to card. The characteristic value function algorithm is then stored in the same location as network-inaccessible processor 16. See the Appendix for a further explanation of the authentication process.

The digital copy of photograph 22 and digital copy of signature 24 are then sent to remote database 14 where they are stored and indexed in a way that allows them to be retrieved when desired to authenticate that particular card.

In operation, when the cardholder presents card 10 for verification it is swiped in conventional card reader 12, which then begins the verification process. Remote secure database 14 is contacted and the digital copies of photograph 22 and signature 24 are retrieved and sent to network-inaccessible processor 16. The cardholder's name and pixel values encoded on storage medium 26 are also sent to processor 16. Processor 16 applies the characteristic value function algorithm to the digital copies of photograph 22 and signature 24 and the values of the pixels determined by the characteristic value function algorithm are read. Since a digital image is stored as a series of discrete pixel value entries in a table, the characteristic value function algorithm will determine the same pixels, and hence the same pixel values, each time; i.e., its repeatability is 100%. Thus every time card 10 is read the pixel values determined by processor 16 will be the same as those that were encoded on storage medium 26 when card 10 was created.

Processor 16 next compares the pixel values it received with the request for authentication to those it determined by applying the characteristic value function algorithm to the digital photograph and signature it received from the remote database. If they are not the same, the card is rejected as counterfeit and a message is returned to display means 18 indicating the rejection. If they are the same, the digital photograph and signature are sent back to display means 18 along with an indication that card 10 and its holder have been authenticated. Displaying photograph 22 and signature 24 on display means 18 allows further visual authentication of the card presenter.

The comparison between the pixel values determined by processor 16 and the pixel values encoded on magnetic strip 26 has been described as analytical, taking place remotely from where the card is presented. In addition, card 10 is created at another remote location, both of which insure that end-to-end security is maintained and the characteristic value function algorithm remains secret.

Also, the digital signature could be stored at a separate location to provide additional security. For even greater security the pixel values on the digital signature could be determined by a second characteristic value function algorithm which would require a second processor, stored in yet another location. Counterfeiting this latter embodiment of card 10 would require that two databases and two network-inaccessible processors be hacked into and/or that two characteristic value function algorithms, even if stored on magnetic strip 26 in assembly language, be reverse engineered, a situation that would provide a very high degree of security.

Obviously also the card could have encoded on magnetic strip 26 one or more pieces of unique information in addition to the picture and signature, thereby increasing the level of security even more.

In the following Appendix Section 1 defines the general terms used in the calculations and describes the context of the calculations. Section 2 contains a high-level overview of the process of creating the data that will be encoded on the card. Section 3 contains a short description of what is actually stored on the card. Section 4 gives a short description of the data that will be used to verify a card when it is presented for verification. Section 5 contains the core mathematics used in implementing the system. Section 6 expands on the contents of Section 5 and describes the preferred embodiment of the analytical methods behind the system of the present invention. Section 7 describes a method of preventing identical data from being encoded onto two or more cards. Section 8 describes methods of implementing the above analytical methods on a computer. Section 9 discusses the memory and storage requirements for a system as shown herein.

1. A secure method of authenticating an identification card comprising providing an identification card having certain unique information recorded thereon, scanning said information to produce a digital copy of said information, and determining part of said secure authenticating system from said digital copy of said information.

2. The method of claim 1 wherein said part of said secure authenticating system comprises first pixel values at selected locations on said digital copy of said information.

3. The method of claim 2 including determining said selected locations according to a characteristic value function algorithm.

4. The method of claim 3 including recording said first pixel values on said identification card in human-readable and/or machine-readable form.

5. The method of claim 5 including storing said digital copy of said information at a first remote location.

6. The method of claim 5 including providing a digital processor at a secure second remote location.

7. The method of claim 6 including storing said characteristic value function algorithm at said secure second remote location.

8. The method of claim 7 including sending said pixel values and said digital copy of said information to said digital processor at said secure second remote location.

9. The method of claim 8 further including applying said characteristic value function algorithm to said digital copy of said information at said secure second remote location to determine second pixel values at said selected locations.

10. The method of claim 9 further comprising comparing said second pixel values determined from said digital copy of said information at said secure second remote location with said first pixel values recorded on said identification card.

11. The method of claim 10 further including comparing said digital copy of said information with said information on said identification card.

12. An authenticating system for an identification card comprising an identification card having certain unique information thereon, means for scanning said unique information to produce a digital copy of said information, means for determining first pixel values at selected locations on said digital copy of said information according to a characteristic value function algorithm, and means for recording said first pixel values on said identification card in human-readable and/or machine-readable form.

13. An authenticating system as in claim 12 further comprising means for recording said digital copy of said information at a first remote location.

14. An authenticating system as in claim 13 further including a digital processor and said characteristic value function algorithm located at a secure second remote location.

15. An authenticating system as in claim 14 further comprising means for sending said pixel values and said digital copy of said information to said secure second remote location.

16. An authenticating system as in claim 15 further including means at said secure second remote location for causing said processor to apply said characteristic value function algorithm to said digital copy of said information to determine second pixel values at said selected locations using said digital processor.

17. An authenticating system as in claim 16 further including means at said secure second remote location for comparing said second pixel values from said digital copy of said information with said first pixel values previously recorded on said identification card.

18. An authenticating system as in claim 17 further including means for transmitting the result of said comparison for viewing at another location.

19. An identification card including certain unique information thereon, said card also having thereon part of a secure authenticating system for said card.

20. An identification card as in claim 19 wherein said part of a secure authenticating system for said card comprises pixel values from selected locations on said unique information, said pixel values produced by scanning said unique information to produce a digital copy of said unique information.

21. An identification card as in claim 20 wherein said locations are selected according to a characteristic value function algorithm.

22. An identification card as in claim 21 wherein said pixel values are recorded on said card in human-readable and/or machine-readable form.

23. An identification card as in claim 22 wherein said characteristic value function algorithm is recorded in a remote secure location.

24. An identification card as in claim 23 wherein said digital copy of said information is stored in a remote secure location.
